(19) United States
(12) Patent Application Publication
(10) Pub. No.: US 2022/0163924 A1
(43) Pub. Date: May 26, 2022

(54) Two-Stage Speed Increaser Arrangement And Gear Train For A Clockwork

(71) Applicant: Maform Kft., Budapest (HU)

(72) Inventor: Geza Csire, Budapest (HU)

(73) Assignee: Maform Kft., Budapest (HU)

(21) Appl. No.: 17/600,256

(22) PCT Filed: Feb. 6, 2020
(86) PCT No.: PCT/HU2020/000007

§ 371 Date: Sep. 30, 2021

(30) Foreign Application Priority Data
Apr. 2, 2019 (HU) P1900107

(51) Int. Cl. G04B 19/02; G04B 13/00; G04B 45/04

(52) U.S. Cl. CPC G04B 19/02; G04B 45/04; G04B 13/00

(57) ABSTRACT

The invention is a two-stage speed increaser arrangement comprising force transmission members having a first, second, third and fourth pitch surface (100A, 100B, 100a, 100b), wherein the first pitch surface (100A) and the third pitch surface (100a) having a common first line segment (102A) and the second pitch surface (100B) and wherein the fourth pitch surface (100b) having a common second line segment (102B).

The two-stage speed increaser arrangement is characterised in that considering as an origin (T1), of an orthogonal coordinate system in a plane (104) perpendicular to the second line segment (102B), a projection of the second line segment (102B) to the plane (104), and considering that the Y axis of the coordinate system is pointing in the direction of a projection point (TO) of a point (D) of the first line segment (102A) to the plane (104), the following Formula 1 is satisfied at all times for the arrangement, in a coordinate system defined for each point (D) of the first line segment (102A):

x(((y′+d)x−x′y)(x²+y²−dy)+d²xy)≥0, Formula 1

wherein
d is the distance of the projection point (T0) from the origin (T1),
x and y are the coordinates of a projection point (K), as projected to the plane (104), of an arbitrary tooth contact point (P) within any tooth contact region of the first pitch surface (100A) and the third pitch surface (100a), and
x′ and y′ are the coordinates of the projection point (K′), as projected to the plane (104), of an arbitrary tooth contact point (P′) situated along any tooth contact region of the second pitch surface (100B) and the fourth pitch surface (100b).

The invention is furthermore a gear train satisfying the above formula.

### TECHNICAL FIELD

The invention relates to a two-stage speed increaser arrangement, and to a gear train for a clockwork (timepieces or movements), for example for watches.

### BACKGROUND ART

Different speed reducer arrangements and/or speed increaser arrangements (speed reducer arrangements and speed increaser arrangements together gearbox arrangements) are known in the prior art.

Documents US 2012/0065018 A1 and US 2014/0018203 A1 disclose speed reducers. The technical solutions set forth in the documents are suitable for speed increasing only at low efficiency and with unfavourable operating conditions, because the relationships between the gearings applied at the two gear stages required for speed increasing are not taken into account. This results in the formation of such internal forces in a gearbox that hampers a speed-increasing action or makes it impossible. For applying reverse drive to the two-stage speed reducers according to the documents (or to similarly arranged reducers), i.e. for applying them as a speed increaser, the internal gears have to be moved relative to each other, which results in a tooth shear at the two mutually engaged stages of the planet gears, rather than a drive of the planetary gear. This phenomenon is largely caused by geometrical reasons, however, as far as inter-tooth friction is concerned, it is essentially similar to the fact that generic worm gears cannot be reverse-driven (i.e. cannot be applied in a speed increaser arrangement).

A speed increaser arrangement implemented by applying circular paths is disclosed in US 2010/0048342 A1. The document does not disclose the relationship between the dimensions and size of the teeth applicable at a first and a second stage of the speed increaser arrangement, so a speed increaser arrangement cannot be provided based on the disclosure of the document.

In the document entitled “Design of a two-stage cycloidal gear reducer with tooth modifications” (Mechanism and Machine Theory 79 (2014) 184-197), Jyh-Jone Lee et al. disclose a two-stage drive, wherein cycloidal teeth with modified tooth profile are applied for reducing kinematic errors, and for providing a compact arrangement with a high reducing ratio. The applied tooth modifications are not aimed at allowing reverse drive, i.e. speed increasing, but to assist in a speed reducing operation.

In the three articles by C. Jaliu et al., (“Dynamic Features of Speed Increasers from Mechatronic Wind and Hydro Systems. Part I: Structure Kinematics”, Ceccarelli M. (eds) Proceedings of EUCOMES 08. Springer, Dordrecht, 351-359 (2009); “Dynamic Features of Speed Increasers from Mechatronic Wind and Hydro Systems. Part II: Dynamic Aspects”, Ceccarelli M. (eds) Proceedings of EUCOMES 08. Springer, Dordrecht, 361-368 (2009), and “Features of a Cycloid Speed Increaser with Double Satellite Gear for Small Mechatronic Wind and Hydro Systems”, Renewable Energy and Power Quality. 1. 795-802 (2009)), reducer arrangements used as speed increasers are disclosed. None of the documents contains a teaching on the relationship between the teeth to be applied at both stages of the gear drives; only a relationship is defined between the internal efficiency of the drive and the applicable gear ratio.

The prior art contains such compact two-stage planetary gearboxes that are capable of speed reduction; however, these solutions typically feature moving the planet gears. Such a technical solution is disclosed for example in US 2017/0045118 A1. These solutions are not applicable for speed increasing, because in them such ring gears have to be rotated relative to each other that have nearly the same number of teeth, and the forces arising at the gears having different diameters and at their common axis result in loads that are difficult to compensate with known tooth types and commonly used materials. The disadvantage of these technical solutions is that they cannot be applied for speed increasing in the gear train of a clock or watch.

A two-stage planetary gear drive with a similar arrangement is disclosed in EP 2,236,823 A1, wherein a two-stage speed increaser planetary gearbox intended for wind turbines is applied, comprising shafts requiring high accuracy and high load-bearing capacity. The document describes the possibility of applying screw, helical or herringbone gears—which require complex manufacturing technology—for reducing axial forces. The disadvantage of such an arrangement is that driving one of the two ring gears results in significant tooth and shaft loads of the planet gears, so the diameter of the planet gears have to be kept under half the diameter of the ring gears, and it is also required to apply more than one planet gear. The solution is not suitable for providing a miniaturized variant applicable for operation in clocks and watches.

The prior art also includes spur gears (with so called straight teeth) that are adapted to produce low radial forces, for example involute gearings generated with a low pressure angle, and cycloidal gears. Document U.S. Pat. No. 4,651,588 also discloses a tooth profile adapted for generating small radial forces. The disadvantage of such profiles is that, when they are applied in two-stage speed increaser planetary gearboxes, the differences between the diameters of the teeth and gear and the characteristics of the arrangement are not taken into account. Such arrangements are therefore more sensitive to manufacturing inaccuracies, which may result in fluctuations of the instantaneous forces that drive the planet gears. On the one hand, such fluctuations reduce the durability of the watch movement, and on the other hand make the arrangement unsuitable for application in mechanical watch movements, because the escapement mechanism adapted for timing is sensitive to torque fluctuations, which can make the timepiece inaccurate.

In mechanical clocks and watches it is necessary to apply speed increaser gears. In addition to displaying time, timepieces may also have additional functionality, the implementations of which are called “complications” in the field. Additional functions implemented by the complications can for example be displaying the date, or a special pointer arrangement, high-speed stopwatch functions, or other interesting functionalities. In spite of these special technical solutions, the drive train of most clocks and watches has been unchanged for a few hundred years; the slow motion of a spring, weight or other slow-moving actuator is sped up for the escapement mechanism providing the accurate running of the mechanism by a usually 6-10 stage gear transmission consisting of external cycloidal gears. In known mechanisms, speed increasing ratios of 1:100 and even 1:10000 can occur. Complications often provide the timepiece a complex outward appearance that makes it more difficult to read the time, and the additional components increase the number of failure modes. Timepiece gear trains that are different from the conventional type are also more complex so have more failure modes, or have to be manufactured by applying a more expensive technology.

The pointing mechanism of a watch comprising a special planetary motion is disclosed in WO 00/31594. The disadvantage of the disclosed solution is that it is capable of providing only small speed increasing ratios, and that its application in timepieces requires a complete watch movement (that can also operate on its own), which greatly complicates the clock or watch mechanism, thereby increasing manufacturing costs and the number of failure modes.

Another special watch movement is disclosed in EP 2 990 880 B1. In this movement, a major part of the gear train of the movement is constituted by the hands (pointers), wherein a balance wheel responsible for timing also rotates. The drawback of this arrangement is that it provides a mechanism for displaying time that has more components and is of higher complexity than conventional watch movements.

A further special watch movement is disclosed in U.S. Pat. No. 2,852,908. In this movement, some of the components of the gear train can be hidden in an outside edge of the watch, so the middle of the watch remains empty and even can be seen through. The drawback of this solution is also the added complexity with respect to conventional watch movements.

US 2012/0287762 A1 discloses a dial module for a further watch comprising a special planetary motion. The disadvantage of the technical solution described in the document is that it is not capable of speed increasing, and that a complete, self-contained watch movement is required for its operation, so it increases the complexity of the timepiece and also the number of failure modes with respect to conventional timepieces.

### DESCRIPTION OF THE INVENTION

The object of the invention is to provide a two-stage speed increaser arrangement (gearbox arrangement) that is capable of providing high speed increasing ratios and has a simple configuration.

Another object of the invention is to provide a gear train for a clockwork that has a compact size, can be applied also in watches, wherein the gear train is integrated in the clock hands.

The objects according to the invention have been achieved by providing a two-stage speed increaser arrangement according claim 1 and a gear train according to claim 4. Preferred embodiments of the invention are defined in the dependent claims.

The advantage of the two-stage speed increaser arrangement according to the invention is that it allows for providing high speed increasing ratios, and can even be applied for precision mechanics applications.

It has been recognised that, if a relationship related to the gearbox arrangement is satisfied, the gearbox arrangement can be applied as a speed increaser, while those reducer gearbox arrangements that satisfy the relationship can be used as speed increaser gearboxes, i.e. the teeth thereof are safely prevented from getting stuck, and no such forces occur that would prevent or hamper their operation as a speed increaser.

A further advantage of the gearbox arrangement according to the invention is that it has a simple configuration, and, provided that the relationship related to the gearbox arrangement according to the invention is satisfied, the gearbox arrangement is less sensitive to manufacturing inaccuracies. The relationship can be satisfied by applying gears that are easy to manufacture, so this requirement does not involve the application of difficult-to-manufacture gears; on the contrary, the gearbox arrangement according to the invention that satisfies the relationship can be implemented by using gears with teeth having simple, easily manufacturable shapes.

The advantage of the gear train according to the invention is that it is integrated in the hands of a clock or watch, wherein the time is being indicated by the position of the gears (instead of conventional clock hands). Thanks to this, the timepiece can be implemented by fewer components, which reduces the chance of failure, while the outward appearance of the timepiece is much more special. However, the special outward appearance does not make reading the time more difficult, because the time is indicated by the gears of the gar train in a similar manner to conventional timepieces.

It has been recognised that, by having multiple gears being arranged in the gear train, the gear train is less sensitive to the effects of friction and manufacturing inaccuracies. This preferably improves the applicability of the gear train in clocks and watches where accuracy and reliability are primary concerns.

### BRIEF DESCRIPTION OF THE DRAWINGS

Preferred embodiments of the invention are described below by way of example with reference to the following drawings, where

FIG. 1 illustrates the relationship between the teeth used in each of the stages of the two-stage speed increaser arrangement according to the invention,

FIG. 2A shows a preferred configuration of the pitch surfaces of the two-stage speed increaser arrangement according to the invention,

FIG. 2B shows another preferred configuration of the pitch surfaces of the two-stage speed increaser arrangement according to the invention,

FIG. 3 shows a preferred implementation of the two-stage speed increaser arrangement according to the invention comprising gear racks and (spur) pinion gears,

FIG. 4 shows a preferred implementation of the two-stage speed increaser arrangement according to the invention comprising spiral bevel gears,

FIG. 5 shows the top plan view of a preferred implementation of the two-stage speed increaser arrangement according to the invention comprising spur gears,

FIG. 6A shows the major force conditions related to the pitch surfaces in the preferred arrangement according to FIG. 5 in the case of applying small-sized teeth,

FIG. 6B shows the major force conditions related to the pitch surfaces in the preferred arrangement according to FIG. 5 in the case of applying normal-sized teeth,

FIG. 6C shows the major force conditions related to the pitch surfaces in the preferred arrangement according to FIG. 5 in the case of applying large-sized teeth,

FIG. 7 illustrates an application of the relationship between the teeth used in each of the stages of the two-stage speed increaser arrangement according to the invention for a gearbox arrangement according to FIG. 5 comprising cycloidal teeth,

FIG. 8 illustrates an application of the relationship between the teeth used in each of the stages of the two-stage speed increaser arrangement according to the invention for a gearbox arrangement according to FIG. 5 comprising shifted involute teeth,

FIG. 9A shows a top plan view of a preferred embodiment of the gear train according to the invention at a time of 12:00 o'clock,

FIG. 9B is the top plan view of the preferred gear train according to FIG. 9A at a time of 10:10 hours,

FIG. 10 is the top plan view of the preferred gear train according to FIG. 9A at other time instants,

FIG. 11 is the isometric exploded view of a further preferred embodiment of the gear train according to the invention,

FIG. 12A is the isometric exploded view of another preferred embodiment of the gear train according to the invention, and

FIG. 12B is the isometric exploded view of a further preferred embodiment of the gear train according to the invention.

### MODES FOR CARRYING OUT THE INVENTION

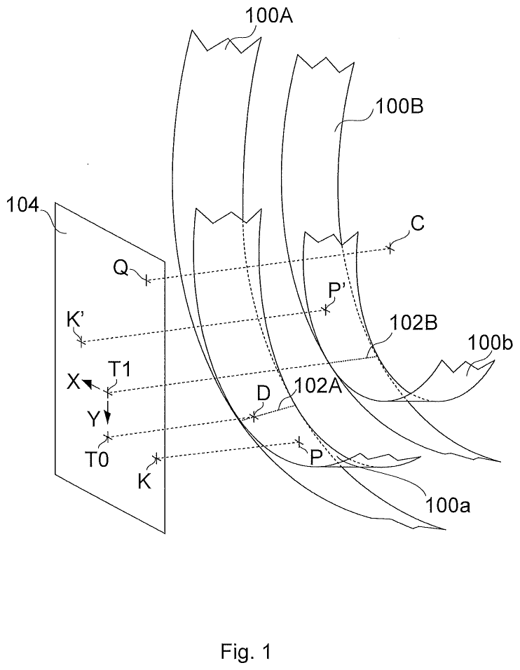

FIG. 1 illustrates the relationship between the teeth used in each of the stages of the two-stage speed increaser arrangement (gearbox arrangement) according to the invention. The speed increaser arrangement comprises force transmission members comprising a first pitch surface 100A, a second pitch surface 100B, a third pitch surface 100a, and a fourth pitch surface 100b. In the first stage, the third pitch surface 100a rolls along the first pitch surface 100A, while in the second stage, the fourth pitch surface 100b rolls along the second pitch surface 100B. Preferably, at least one of the force transmission members is a gear wheel, a bevel gear, a helical gear, a spiral gear, or hypoid gear, the other force transmission members being gear members and/or chain transmission members, preferably a chain or a sprocket wheel. For the sake of simplicity, hereinafter the term “teeth” is used to refer to the interconnected chain portions of chain transmission members as well as to the teeth of gear members.

The teeth are arranged either at fixed positions, or, in the case of chain transmission members and sprockets, at non-fixed positions with respect to the pitch surfaces 100A, 100B, 100a, 100b. The teeth are preferably being different from each other, or identical or partially identical to each other having arbitrary shapes as long as the shape of the teeth does not block rolling.

Due to the rolling action, in the first stage, the first pitch surface 100A and the third pitch surface 100a have a first line segment 102A, preferably continuously have only one first line segment 102A, and in the second stage, the second pitch surface 100B and the fourth pitch surface 100b have a second line segment 102B, preferably continuously have only one second line segment 102B, along which line segments 102A and 102B, in the course of the rolling action, the third pitch surface 100a touches the first pitch surface 100A and the fourth pitch surface 100b touches the second pitch surface 100B, respectively. Both stages have at least one respective tooth contact region, arranged spaced apart with respect to the line segments 102A, 102B, along which the force transmission members of the first stage and second stage can engage. In both stages of the gearbox arrangement, at all times when rolling occurs, there is at least one respective pair of teeth in contact at the contact region of the first pitch surface 100A and the third pitch surface 100a and also at the contact region of the second pitch surface 100B and the fourth pitch surface 100b, of which pair one tooth corresponds, respectively, to the first pitch surface 100A or the second pitch surface 1008, and the other tooth corresponds, respectively, to the third pitch surface 100a or the fourth pitch surface 100b, wherein the regions of mutual contact of these pairs of teeth are the tooth contact regions, along which tooth contact regions the teeth of the respective stages contact each other by sliding or rolling, or, for example in the case of chains, by rolling on the tooth surfaces.

The relative position of the first and second pitch surfaces 100A and 1008 at the first and second line segments 102A and 102B is fixed, wherein the relative position of the third and fourth pitch surfaces 100a and 100b at the first and second line segments 102A and 102B is also fixed, where being fixed means that, at the first and second line segments 102A and 102B, the relative position of the first and second pitch surfaces 100A and 1008, as well as the relative position of the third and fourth pitch surfaces 100a and 100b does not change, i.e. they are not being shifted with respect to each other. Preferably, the relative position of the teeth corresponding to the first pitch surface 100A and to the second pitch surface 1008, or the relative position of the teeth corresponding to the third pitch surface 100a and to the fourth pitch surface 100b also do not change.

The projection of the second line segment 1028 to a plane 104 (that is perpendicular to the line segment 102B) is the origin T1 of the plane 104, with a corresponding orthogonal coordinate system in the plane 104. The Y axis of the coordinate system points in the direction of a projection point T0 of a point D of the first line segment 102A to the plane 104, wherein the projection of the geometrical centre point C of the third pitch surface 100a and the fourth pitch surface 100b to the plane 104 is a point Q.

In coordinate systems defined for each point D of the first line segment 102A, the two-stage speed increaser arrangement according to the invention satisfies the following Formula 1, at all times:

x(((y′+d)x−x′y)(x²+y²−dy)+d²xy)≥0, Formula 1

which, if satisfied, ensures that the gearbox arrangement is capable of speed increasing, and wherein

d is a distance of a projection point T0 from the origin T1,

x and y are the coordinates of a projection point (point K) to the plane 104 of any tooth contact point P within the tooth contact region between the first pitch surface 100A and the third pitch surface 100a, and

x′ and y′ are the coordinates of a projection point (point K′) to the plane 104 of any tooth contact point P′ within the tooth contact region between the second pitch surface 1008 and the fourth pitch surface 100b.

Formula 1 is based on a geometrical consideration that the engagement points of the teeth of mutually engaged pairs of teeth in two-stage gearbox arrangements are located at opposite sides of the teeth. The non-trivial relationship expressed by Formula 1—not applied in the field so far—sheds light on the fact that the positions of the pressure points of the two opposite sides are dependent on each other if the aim is to achieve an instantaneous rolling action in a gearbox arrangement, and also points out why the majority of high gear-ratio two-stage planetary gearboxes cannot be driven in reverse, i.e. why they cannot be applied as speed increasers.

According to the current engineering practice, each gear is dimensioned separately. The selected dimensions either do not affect the dimension of gears that are not in direct engagement, or do so only very indirectly. In the technical field of the invention, two-stage gearbox arrangements are typically not designed for speed increasing, so the direct effect of the geometry of mutually engaged teeth used in different stages has not yet been investigated in relation to designing such gearboxes for speed increaser arrangements. It is unexpected for a person skilled in the art that the dimensions of an engaged pair of teeth used in one of the stages of the two-stage gearbox arrangement directly affect the dimensions of a mutually engaged pair of teeth applicable in the other stage. Furthermore, the result that the gearbox arrangement according to the invention can be applied for speed increasing by a factor of multiple hundreds is surprising for the skilled person. The gear train (also known as a drive train, or a gear wheel arrangement) according to the invention has not been applied for clocks and watches so far, because this type of drive train was typically known for as a speed reducer, and because in the known examples used as a speed increaser arrangement the speed increasing ratio is under 1:30. The application of the gearbox arrangement and gear train according to the invention is particularly preferable in the case of clocks and watches due to the greater-than-before speed increasing capability and safer operational characteristics that can be realized in a compact form factor, using a low number of parts.

During normal operation of two-stage planetary gearboxes, the points in engagement on the teeth of the two stages are on the same side of the teeth, from which it does not follow that for a reverse drive case the points in engagement will be on opposite sides of a teeth. For example, if constant contact-lines exist in a two-stage gearbox arrangement, for example in a gearbox arrangement with identical teeth, then, in the case of a reverse drive, only one of the two contact-lines is reversed, and is shifted to the other side of the instantaneous rolling action. Due to the above considerations, the feasibility of a reversed drive cannot be trivially examined; Formula 1 gives an easily testable formula for solving the problem.

Because the relationship according to Formula 1 involves only the operations of addition, subtraction and multiplication, the computational demand of the formula is low, which allows for easy verification of its fulfilment for any two-stage gearbox arrangement.

The quantities d, x, y, x′ és y′ in Formula 1 are preferably specified in millimetres.

A more efficient and more robust arrangement that is less sensitive to the negative effects of friction than the gearbox arrangement satisfying Formula 1 can be obtained if the arrangement also satisfies the relationship expressed in Formula 2 below:

x(y′x−x′y)(x²+y²−dy)≥0, Formula 2

wherein the variables are identical to the variables included in Formula 1, and are preferably also specified in millimetres. Those two-stage speed increaser arrangements that satisfy the relationship according to Formula 2 at all times for all teeth in engagement also automatically satisfy the relationship according to Formula 1. Also satisfying Formula 2 in addition to Formula 1 results in more efficient operation.

Speed increasing can be implemented in two distinct ways in the gearbox arrangement: in the first case, the teeth of the first pitch surface 100A and the teeth of the second pitch surface 100B are in motion relative to each other along their own respective surfaces, while in the second case, the teeth of the third pitch surface 100a and the teeth of the fourth pitch surface 100b are in motion relative to each other along their own respective surfaces. In both cases, due to the motion of the teeth, the third pitch surface 100a and the fourth pitch surface 100b are collectively moved with respect to the first pitch surface 100A and the second pitch surface 100B. The factor of speed increasing (acceleration) performed by the gearbox arrangement is obtained by the following Formula 3:

$$a c c \approx \frac{‖ T 0 ‖ + ‖ Q ‖}{‖ T 0 ‖} , \qquad Formula 3$$

where

acc is the factor of acceleration, and

∥T0∥ and ∥Q∥, respectively, denoting the Euclydean norm of the points T0 and Q corresponding to the distance of the points T0 and Q from the origin T1 of the plane 104.

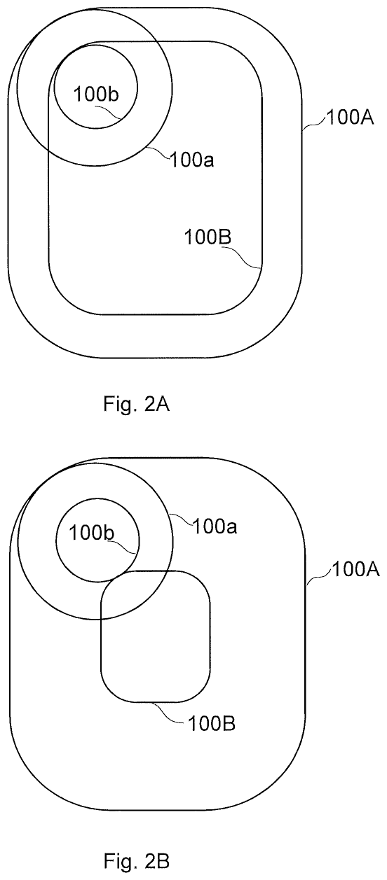

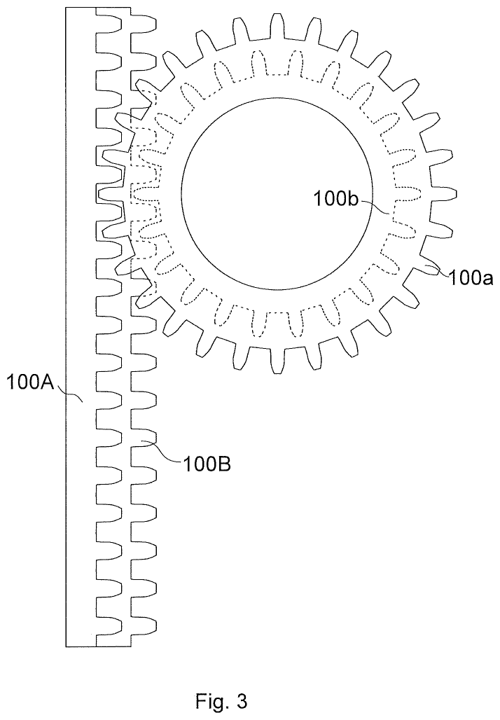

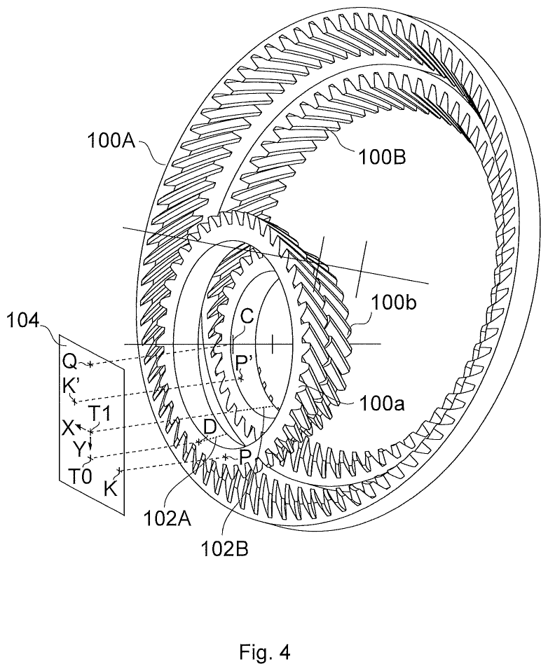

The speed increasing action can be achieved between various convex and concave pitch surfaces that can even be different or open surfaces. FIGS. 2A and 2B illustrate a respective preferred embodiment of the speed increaser arrangement according to the invention arranged in a plane that comprises pitch surfaces having curved and straight sections. FIG. 3 illustrates a preferred gearbox arrangement consisting of gear racks and pinion gears, FIG. 4 shows a preferred embodiment of the two-stage speed increaser gearbox arrangement according to the invention having spiral bevel gears. Of course, in addition to the ones shown in FIGS. 2A, 2B and FIGS. 3-4 further preferred configurations can also be realized, for example by combining certain portions of the gearbox arrangements depicted in the figures.

By applying Formula 1, or, for the sake of a more robust operation, by applying Formula 2, it can be decided for any two-stage gearbox arrangement whether the gearbox arrangement is suitable for being operated as a speed increaser arrangement. If the relationship according to Formula 1 is not satisfied at all times for a two-stage gearbox arrangement, then that particular gearbox arrangement is not capable of being operated as a speed increaser arrangement. However, if the relationship according to Formula 1 is satisfied for the gearbox arrangement under scrutiny but the condition according to Formula 2 is not fulfilled, then, although the gearbox arrangement in question can be operated as a speed increaser, a gearbox arrangement can be realised with a more efficient gear configuration or gear profile.

If one of the stages of a two-stage gearbox arrangement has a well-determined tooth configuration, then such engagement points can be determined by in the other stage, by applying Formula 1 or Formula 2, for which points the relationship according to Formula 1 or Formula 2 is satisfied. For example, in such a two-stage gearbox arrangement wherein both stages comprise predetermined (even completely different) tooth configurations, those engagement points and tooth contact regions for which the relationship according to Formula 1 or Formula 2 is satisfied can be determined, and thus, such a speed increaser gearbox arrangement is obtained that can be operated by applying mutually engaged teeth corresponding to the engagement points or tooth contact regions, and that satisfies Formula 1 or Formula 2 for all operating states of the mutually engaged teeth thereof.

By applying Formulas 1 or 2, the maximum area of the surfaces of action of each of the teeth of the two-stage speed increaser arrangement can be determined at all states of the speed increaser arrangement. In speed increaser arrangements, wherein the pitch surfaces are circular, and the surfaces of action have identical configuration along the pitch surfaces, the dimensions of the applicable surfaces of action of the teeth can be determined from any state of a gearbox arrangement, and the applicable tooth types can also be determined.

FIG. 2A shows, in top plan view, the pitch surfaces of a preferred embodiment of the two-stage speed increaser arrangement according to the invention comprising flat (spur) gear components. The gearbox arrangement according to the figure can also be implemented by applying bevel gear components, in which case FIG. 2A essentially shows a section of the pitch surfaces of the gearbox arrangement. The first pitch surface 100A and the second pitch surface 100B comprise curved and straight sections that are adapted to receive the third pitch surface 100a and the fourth pitch surface 100b, respectively for rolling therein (as discussed in relation to FIG. 1). In the preferred embodiment according to the figure, the third pitch surface 100a and the fourth pitch surface 100b have circular shape as seen in top plan view. The pitch surfaces 100A, 100B, 100a, 100b can for example correspond to flat (spur) gears or bevel gears with arbitrary tooth configurations, having mutually engaged teeth satisfying the relationship according to Formula 1 or Formula 2. The features and alternatives disclosed in relation to FIG. 1 are applicable for the pitch surfaces 100A, 100B, 100a and 100b.

The gearbox arrangement according to FIG. 2A is capable of displaying time, and thereby also for being used as a watch movement. In the configuration according to the figure, if the first and second pitch surfaces 100A, 100B and the corresponding teeth are stationary relative to each other, or are in a fixed relative position, and if, under the effect of a motor, spring, or other drive mechanism, the third pitch surface 100a, together with the teeth corresponding thereto, is rotated with respect to the fourth pitch surface 100b such that the teeth corresponding to the fourth pitch surface 100b do not move along the fourth pitch surface 100b, then the pitch surfaces 100a and 100b will roll together circularly along the pitch surfaces 100A and 100B. If the pitch surfaces 100a and 100b move relative to each other in a timed manner, i.e. for example the angular displacement of the pitch surfaces 100a and 100b in a unit time (for example, in a second) is always identical, then the pitch surfaces 100a and 100b rotate along the same portions of the pitch surfaces 100A and 100B at the same speed, and thereby the duration of a full rotation is constant. Starting the rotation at an arbitrary point, the pitch surfaces 100a and 100b return to their starting point when the duration of a full rotation has elapsed, which makes the gearbox arrangement according to FIG. 2A suitable for application in single-hand clocks or watches, wherein the hand completes a full rotation in for example a day, or in another embodiment, in half a day (12 hours).

A characteristic feature of the gearbox arrangement according to FIG. 2A is that the rotational speed of the hands is different along sections with different curvature. The circular motion is faster along the greater-curvature portions, so the hour markings of the dial of the timepiece comprising the gearbox arrangement according to the figure are spaced more widely apart along the greater-curvature or straight sections than along the portions with a smaller curvature.

For applying the gearbox arrangement in a watch movement, i.e. for implementing the timing functionality, a rapid motion of the components of the gearbox arrangement is required. By applying gears with an appropriately selected number of teeth, even a 300-400-fold acceleration can be achieved in the preferred gearbox arrangements according to FIG. 1 or FIG. 2A. Thanks to this speed increasing action, the slow relative movement of the pitch surfaces 100a and 100b can be accelerated to correspond to the fast motion of a balance wheel or other timer mechanism required for providing timing in the clock movement.

In the preferred gearbox arrangement according to FIG. 2A, in case the teeth corresponding to the first pitch surface 100A are arranged on a chain or in a similar manner, i.e. the teeth are allowed to move along the pitch surface 100A, and in case the pitch surfaces 100a and 100b and the teeth corresponding thereto are stationary relative to each other, and also in case the pitch surfaces 100A and 100B are stationary relative to each other, wherein the teeth corresponding to the pitch surface 100B is not moved along the pitch surface 100B, then the displacement of the teeth along the pitch surface 100A will result in the collective circular rolling of the pitch surfaces 100a and 100b inside the pitch surfaces 100A and 100B, respectively. If the teeth move along the pitch surface 100A in a timed manner, then the circular rolling motion of the pitch surfaces 100a and 100b can be used for time measurement.

FIG. 2B shows, in top plan view, the pitch surfaces of another preferred embodiment of the two-stage speed increaser arrangement according to the invention. Of course, also this gearbox arrangement can be implemented by using bevel gear members, in which case FIG. 2B corresponds to a section of the pitch surfaces. The preferred gearbox arrangement according to FIG. 2B differs from the gearbox arrangement according to FIG. 2A in that the fourth pitch surface 100b rolls along the outside (rather than along the inside) of the second pitch surface 100B. Otherwise, the features and alternatives described in relation to FIGS. 1 and 2A also apply to the gearbox arrangement according to FIG. 2B, so this gearbox arrangement is also suitable for being applied in a watch movement.

FIG. 3 shows a preferred embodiment, applying gear racks and (spur) pinion gears, of the pitch surface of the two-stage speed increaser arrangement according to the invention. In a preferred gearbox arrangement according to FIG. 3, the first and second pitch surfaces 100A and 100B correspond to straight gear racks, with the pitch surfaces 100a and 100b of pinion gears being adapted to roll along the pitch surfaces 100A and 100B of the gear racks. In FIG. 3, those edges of the gear racks and gear wheels that are obstructed from view are shown in dashed lines. The features and alternatives described in relation to FIG. 1 also apply to the two-stage speed increaser gearbox arrangement according to FIG. 3.

FIG. 4 shows a preferred realization of the pitch surfaces of the two-stage speed increaser gearbox arrangement according to the invention using spiral bevel gears. FIG. 4 also comprises the references included in FIG. 1, including the projections to the plane 104.

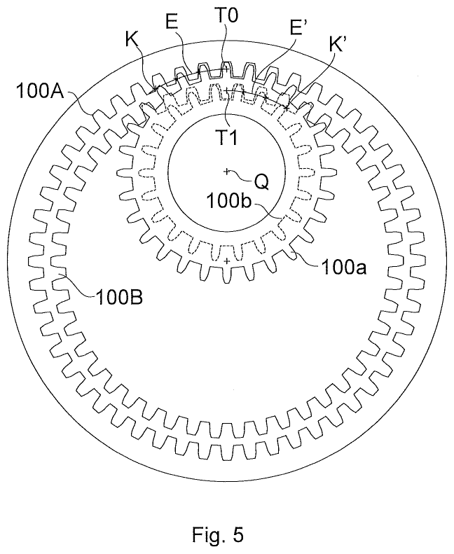

FIG. 5 shows the top plan view of a preferred embodiment of the two-stage speed increaser arrangement according to the invention comprising spur (flat) gears. In the case of spur gears, the first line segment 102A and the second line segment 102B are perpendicular to the plane of the gears, so the plane 104 can be chosen to coincide with the plane of the gears, which implies that the projections can be indicated, by applying the references of FIG. 1, also in the plane of the gears. In FIG. 5, the internal gear having the second pitch surface 100B is arranged under the internal gear having the first pitch surface 100A, with the external gear having the fourth pitch surface 100b being arranged under the external gear having the third pitch surface 100a. Those portions of the gears that are obstructed from view are shown in dashed lines in the figure. The gears in FIG. 5 are cycloidal-profile spur gears (with straight teeth).

In the gearbox arrangement according to FIG. 5, the projection point Q of the common geometrical centre point C of the third pitch surface 100a and the fourth pitch surface 100b circles around the common centre point of the first and second pitch surfaces 100A and 1008. If the teeth corresponding to the third and fourth pitch surfaces 100a and 100b move with respect to each other, and the teeth corresponding to the first pitch surface 100A do not move relative to the teeth of the second pitch surface 1008, then the speed of rotation w_{Q} of the third and fourth pitch surfaces 100a and 100b can be determined by applying the following Formula 4:

$${ω}_{Q} = {ω}_{a b} \frac{{r}_{a} {r}_{b}}{{r}_{a} {r}_{B} - {r}_{A} {r}_{b}} , \qquad Formula 4$$

wherein

ω_{ab} is the speed of the relative rotation of the teeth corresponding to the pitch surfaces 100a and 100b,

r_{A} is the radius of the first pitch surface 100A,

r_{B} is the radius of the second pitch surface 1008,

rₐ is the radius of the third pitch surface 100a, and

r_{b} is the radius of the fourth pitch surface 100b.

In case the teeth corresponding to the third and fourth pitch surfaces 100a and 100b are stationary (fixed) with respect to each other, and the teeth corresponding to the first pitch surface 100A can be rotated around the common centre point or axis of the first pitch surface 100A and the second pitch surface 1008, then the rotational speed w_{Q} of the third and fourth pitch surfaces 100a and 100b, which is identical to the factor of speed increasing (acceleration) of the gearbox arrangement, can be determined according to Formula 5:

$${ω}_{Q} = - {ω}_{A} \frac{{r}_{A} {r}_{b}}{{r}_{a} {r}_{B} - {r}_{A} {r}_{b}} , \qquad Formula 5$$

wherein

ω_{A} is the speed of the rotation of the first pitch surface 100A around the common centre point or axis of the first pitch surface 100A and the second pitch surface 1008, the other variables being identical to the ones included in Formula 4.

In case the teeth corresponding to the third and fourth pitch surfaces 100a and 100b are stationary (fixed) with respect to each other, and the teeth corresponding to the second pitch surface 1006 can be rotated around the common centre point or axis of the first pitch surface 100A and the second pitch surface 1006, then the rotational speed w_{Q} of the third and fourth pitch surfaces 100a and 100b, which is identical to a factor of the speed increasing (acceleration) of the gearbox arrangement, can be determined according to Formula 6:

$${ω}_{Q} = {ω}_{B} \frac{{r}_{a} {r}_{B}}{{r}_{a} {r}_{B} - {r}_{A} {r}_{b}} , \qquad Formula 6$$

wherein

ω_{B} is the speed of the rotation of the first pitch surface 1006 around the common centre point or axis of the first pitch surface 100A and the second pitch surface 1006, the other variables being identical to the ones included in Formula 4 and Formula 5.

In the preferred gearbox arrangement according to FIG. 5, i.e. when a planar configuration of spur gears is applied, the possible dimensions of the surfaces of action of the teeth can be obtained according to Formulas 1 and 2. In the preferred gearbox arrangement according to FIG. 5, the teeth corresponding to the first and third pitch surfaces 100A and 100a can, in every time instance, be mutually engaged along such tooth contact regions of which the tooth contact points P according to FIG. 1 have their respective projections to the plane 104 at respective points K, wherein the points K are arranged along a contact-line segment E of the first pitch surface 100A and the third pitch surface 100a. The shape of the contact-line segment E of the preferred gearbox arrangement according to the figure does not change over time.

The teeth corresponding to the second and fourth pitch surfaces 1006 and 100b can, at all times, be mutually engaged along such tooth contact regions of which the tooth contact points P′ according to FIG. 1 have their respective projections to the plane 104 at respective points K′, wherein points K′ are arranged along a contact-line segment E′ of the second pitch surface 1006 and the fourth pitch surface 100b. In the preferred gearbox arrangement according to the figure, the shape of the contact-line segment E′ does not change over time, just like the relative position of the contact-line segments E and E′.

If the contact-line segment E is known, then a single working tooth profile can be unequivocally determined, and the single working tooth profile for a known contact-line segment E′ can also be unequivocally determined. The features related to the contact-lines E and E′ are present in all similar gearbox arrangements, in case the surface of action of the applied teeth is identical along each of the pitch surfaces 100A, 100B, 100a and 100b, and in case the pitch surfaces 100A, 100B, 100a and 100b have a circular shape. For example, if the surface of action of the applied teeth is a circular arc, and all the gear wheels have ellipsoidal shapes, then the shape of the contact-line segments E and E′ will change over time.

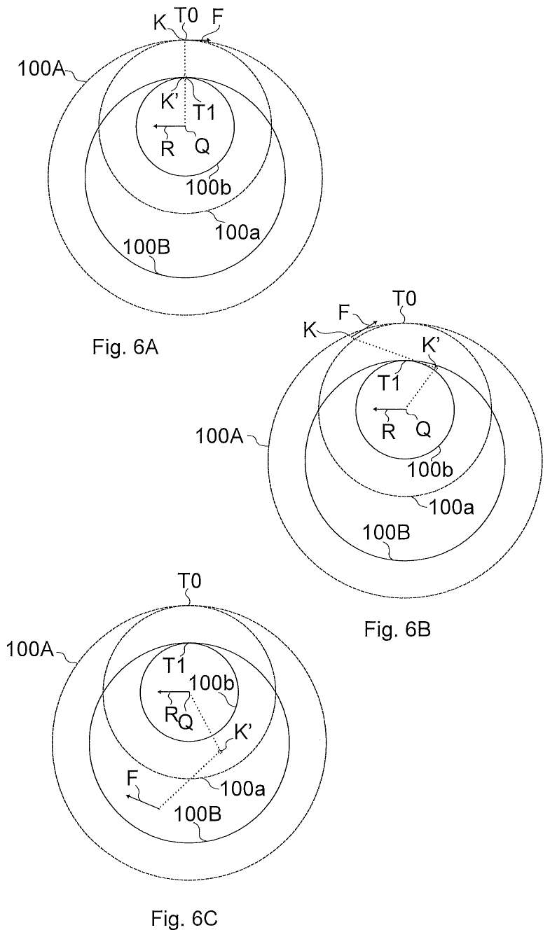

FIGS. 6A-6C show examples of the major internal force conditions of the preferred two-stage speed increaser arrangement according to FIG. 5, with the teeth having different sizes with respect to the pitch surfaces. In the example according to FIG. 6A, the size of the teeth of the gearbox arrangement is negligible compared to the radius of the pitch circles; in the example according to FIG. 6B the teeth corresponding to the pitch surfaces have average size, while in the example according to FIG. 6C large-sized teeth (for example a complete cycloidal arc) are included. References in FIGS. 6A-6C are identical to the references used in FIG. 1, while in addition—due to the applied spur gears—the plane 104 is also arranged in the plane of the (spur) gears, wherein the projections of the first and second line segments 102A and 102B to the plane 104 are being single points (the origin T1 and the point T0, respectively), and wherein the projections of the tooth contact regions to the plane 104 are also being respective single points, such as the points K and K′.

In FIGS. 6A-6C, the teeth corresponding to the second pitch surface 100B are fixed, while the third and fourth pitch surfaces 100a and 100b circle together around their common centre point Q, while circle inside the common-axis first and second pitch surfaces 100A and 100B. During circling, the teeth corresponding to the third pitch surface 100a are mutually engaged, at all times, with the teeth of the first pitch surface 100A, wherein the projections of the tooth contact points P of the engaged teeth are coinciding with the points K in the figure. Likewise, the teeth of the fourth pitch surface 100b are mutually engaged, at all times, with the teeth of the second pitch surface 100B, wherein the projections of the tooth contact points P′ of the engaged teeth are coinciding with the points K′ in the figure. The constant engagement of the teeth is ensured by bearings, or by other known technical solutions or constraints.

The common centre point Q of the third and fourth pitch surfaces 100a and 100b can be moved only in a direction R marked in FIGS. 6A-6C, for example due to the application of bearings or other constraints.

The first pitch surface 100A is rotated, by a spring or other drive mechanism, in a counterclockwise (positive) direction, which results in the displacement of the teeth in the point K in direction F. The third and fourth pitch surfaces 100a and 100b “try” to rotate around the point K′, as the teeth corresponding to the second pitch surface 100B are fixed, so they are in a stationary position. For the sake of simplicity, the effects of tooth slip and of the common tangent of the tooth profiles, located at the points K and K′, are neglected.

In the example according to FIG. 6A, due to the small-sized teeth, the force conditions are similar to a first class lever, wherein the third and the fourth pitch surfaces 100a and 100b are rotated around a point K′ by a force acting in direction F. The gearbox arrangement according to the figure can be operated safely, however, smaller-sized teeth are more difficult to manufacture than larger ones, while smaller teeth are also weaker compared to larger teeth. Moreover, with small-sized teeth, manufacturing inaccuracies, tolerances, impurities or surface defects may greatly affect the exerted forces.

In FIG. 6B, only the points K and K′ located furthest from the point T0 are shown, but other points K and K′, for example the ones indicated in FIG. 6A, may also exist. However, the greatest rotating effect is exerted by the forces acting at the points K and K′ located furthest from the point T0. In the case of normal-sized teeth, the gearbox arrangement comprising teeth having a maximum size obtained from Formulas 1 and 2 can be operated safely, and in a stable manner, while larger teeth are also simpler to manufacture, and the effects of occasional manufacturing inaccuracies and tolerances are also smaller than with small-sized gears.

Also in FIG. 6C only the points K and K′ located furthest from the point T0 are shown. Due to the larger size of the teeth, these points are located even further from the point T0 than the points shown in FIGS. 6A and 6B. Of course, at the locations corresponding to the points K and K′ in FIGS. 6A and 6B further points K and K′ can also be present. With larger-sized teeth, such as teeth having a complete cycloidal-arc profile, it can be seen that, if the third and fourth pitch surfaces 100a and 100b rotate around a point K′ in a direction F, such a rotation essentially counteracts the motion of the third and fourth pitch surfaces 100a and 100b, while in certain cases the displacement of the centre point Q in a direction

R can also be hampered. Such a case can be, for example, when contamination enter between the wheels, or when, due to manufacturing inaccuracies, the largest forces occur at the furthest points K and K′. Although, taking into account all effects, a displacement of the centre point Q of the third and fourth pitch surfaces 100a and 100b in the direction R can also occur in the case of large-sized teeth, however, the gearbox arrangement operates more efficiently and more securely if smaller-sized teeth are applied.

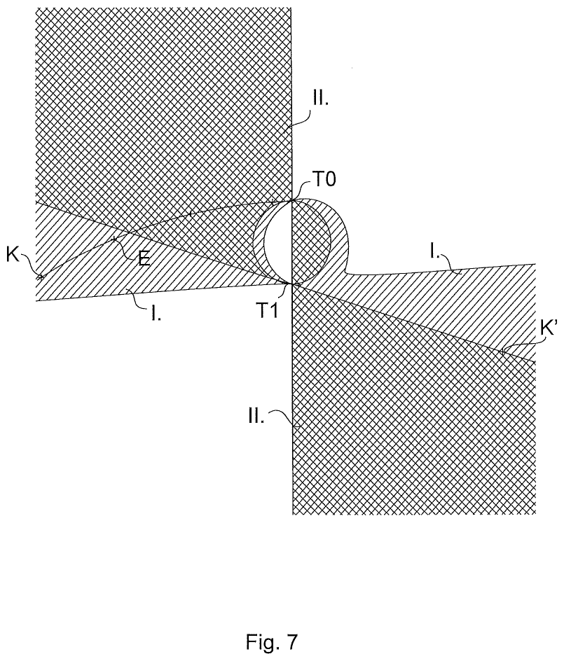

FIG. 7 illustrates an application of the relationship between the teeth used in each of the stages of the two-stage speed increaser gearbox arrangement according to the invention for the preferred gearbox arrangement according to FIG. 5, wherein the gearbox arrangement comprises teeth with a cycloidal profile. The references used in FIG. 7 are the same as used in FIG. 5, the point K indicating a projection of the tooth contact points P located furthest from the point T0, wherein ‘+’ signs indicates the projections of further tooth contacts points P potentially occurring along the contact-line segment E. In the case of teeth with a cycloidal profile, the contact-line segment E corresponding to the pitch surfaces 100a and 100A forms a part of a circular line with a radius that is greater than the radius of the pitch surface 100a and smaller than the radius of the pitch surface 100A. For teeth with a generic cycloidal profile, the radius of the circle corresponding to the contact-line segment E is approximately

$$\approx \frac{{r}_{A} + {r}_{a}}{2} ,$$

wherein r_{A} is the radius of the pitch surface 100A, and rₐ is the radius of the pitch surface 100a.

In the case of teeth with a cycloidal profile, the contact-line segment E′ corresponding to the pitch surfaces 1008 and 100b forms a part of a circular line with a radius that is greater than the radius of the pitch surface 100b and smaller than the radius of the pitch surface 1008. For teeth with a generic cycloidal profile, the radius of the circle corresponding to the contact-line segment E′ is approximately

$$\approx \frac{{r}_{B} + {r}_{b}}{2} ,$$

wherein r_{B} is the radius of the pitch surface 1008, and r_{b} is the radius of the pitch surface 100b.

In FIG. 7 those contact-line segments E are illustrated for which—if the contact-line segment E′ is known, and if the teeth corresponding to the pitch surfaces 100A, 1008, 100a and 100b all have a cycloidal profile—the relationships according to Formulas 1 and 2 are satisfied. The single-hatched Region I. denotes those areas for which the relationship according to Formula 1 is satisfied, while the double-hatched Region II.—which is located in its entirety within Region I.—denotes such areas for which the relationship according to Formula 2 is also satisfied.

Gearbox arrangements that cannot be used for speed increasing, i.e. the gearbox arrangements for which the relationship according to Formula 1 is not satisfied, could be successfully operated as a reducer gearbox, but are completely unsuitable, or can be applied with very low efficacy, for speed increasing in reverse drive, for example because in reverse drive an engagement of teeth hampers the rolling. In these gearbox arrangements—that are not applicable for speed increasing—at least part of the contact-line segment E falls outside of Region I. according to Formula 1.

If the entirety of the contact-line segment E of a gearbox arrangement falls inside Region I. according to Formula 1, and at most only a small part thereof falls inside Region II., then the particular gearbox arrangement (for example, a reducer gearbox arrangement in reverse drive) is suitable for speed increasing; however, a more efficient operation can be achieved for example by modifying tooth shapes or dimensions of the gears.

If the entirety of the contact-line segment E of a gearbox arrangement falls inside region II according to Formula 2, then the particular gearbox arrangement is suitable for speed increasing, wherein the operation of the gearbox arrangement being operated as a speed increaser is efficient, and is less sensitive to the negative effects of friction and manufacturing inaccuracies compared to a gearbox arrangement for which only the relationship according to Formula 1 is satisfied.

The dimensions of the pitch surfaces 100A, 100B, 100a, 100b of an exemplary gearbox arrangement according to FIG. 5 comprising spur gears are the following:

the diameter of the first pitch surface 100A is 52 mm,

the diameter of the second pitch surface 100B is 46 mm,

the diameter of the third pitch surface 100a is 28 mm, and

the diameter of the fourth pitch surface 100b is 22 mm.

By applying spur gears, the projections of the first line segment 102A of the first pitch surface 100A and the third pitch surface 100a, and the second line segment 102B of the second pitch surface 100B and the fourth pitch surface 100b are respective single points in the plane 104 that is perpendicular to the line segment 102A, wherein plane 104 can also be drawn to coincide with the plane of the gear wheels. The projection of the first line segment 102A is the point T0, and the projection of the second line segment 102B is the origin T1, the point T0 and the origin T1 lying at a distance d from each other, the distance d being equal to the difference of the radii of the first and second pitch surfaces 100A and 100B, or the difference of the radii of the third and fourth pitch surfaces 100a and 100b, i.e., using the above specified values, d=3 mm.

In the following, two examples are set forth for gearbox arrangements having the above geometrical parameters and different tooth profiles.

### Example 1 (Cycloidal Tooth Profile)

If the teeth corresponding to the second and fourth pitch surfaces 100B and 100b have cycloidal profile and a module of 1 mm, then, by applying the relationship according to Formula 1, cycloidal-profile teeth with a module of 1 mm can also correspond to the first and third pitch surfaces 100A and 100a. By applying the relationship according to Formula 2, teeth having a cycloidal profile and a module of maximum 0.5 mm can correspond to the first and third pitch surfaces 100A and 100a. By reducing the module of the cycloidal-profile teeth corresponding to the second and fourth pitch surfaces 100B and 100b, the module of the teeth corresponding to the first and third pitch surfaces 100A and 100a can be increased, by applying the relationship according to Formula 1 and also the relationship according to Formula 2.

### Example 2 (Involute Tooth Profile)

In case the teeth corresponding to the second and fourth pitch surfaces 100B and 100b have a module of 1 mm and an involute tooth profile, i.e. teeth without profile shift or other modifications, then, the application of the relationship according to Formula 2 indicates that no such area exists that could contain the contact-line segment E, so there is no such gearbox arrangement comprising involute-profile teeth that could be operated as a speed increaser efficiently, with low sensitivity to frictional effects. This does not exclude the possibility that there exist less efficient gearbox arrangements satisfying the relationship according to Formula 1. Because in the case of involute teeth the various points K′ can be located at both sides of the origin T1, Regions II obtained applying Formula 2 do not have an intersecting area, while an intersecting area of Regions I determined applying Formula 1 is essentially point-like around the point T0, so the position of the points K will be very sensitive to manufacturing inaccuracies. Therefore, there may exist less efficient gearbox arrangements that comply with the relationship according to Formula 1, but there does not exist an elementary involute solution satisfying the relationship according to Formula 2.

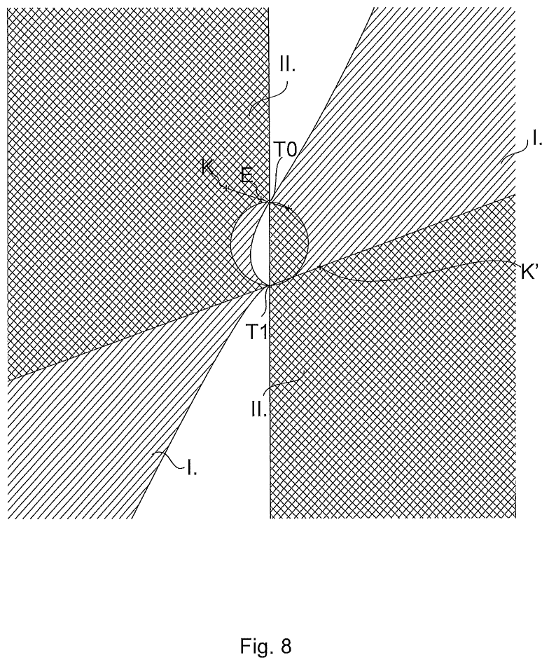

FIG. 8 illustrates an application of the relationship between the teeth utilized in each of the stages of the two-stage speed increaser arrangement according to the invention for the preferred gearbox arrangement according to FIG. 5, wherein the gearbox arrangement has shifted-profile involute teeth along the contact-line segment E (i.e. along the pitch surfaces 1008 and 100b) that allow for satisfying the relationship according to Formula 2. To provide a configuration that provides more secure operation and satisfies the relationship according to Formula 2, the contact-line segment E′ has to be shifted, by applying a profile shift, outside the second pitch surface 1008. FIG. 8 presents how the relationships according to Formulas 1 and 2 are satisfied for such a gearbox arrangement having a shifted-profile, just like in FIG. 7, the single-hatched Region I is the area wherein the relationship according to Formula 1 is satisfied, and the double-hatched Region II is the area wherein the relationship according to Formula 2 is satisfied. Region II is located in its entirety within Region I.

In a gearbox arrangement having identical dimensions to Examples 1 and 2, if the contact-line segment E′ having an elementary involute tooth profile falls, due to a profile shift, outside the second pitch surface 1008, then—independent of the module of the teeth corresponding to the second and fourth pitch surfaces 1008 and 100b—the maximum module of the elementary involute teeth corresponding to the first and third pitch surfaces 100A and 100a can be 1 mm, which module value can be further increased by applying a profile shift to this profile. Therefore, a speed increaser arrangement configured to satisfy the formula according to Formula 2 is also possible by applying an involute tooth-profile gearbox arrangement.

The mutually engaged components of the gear train according to the invention satisfy the relationship according to Formula 1, and preferably also satisfy Formula 2. The gear train according to the invention is applied for timepieces, for example in watches.

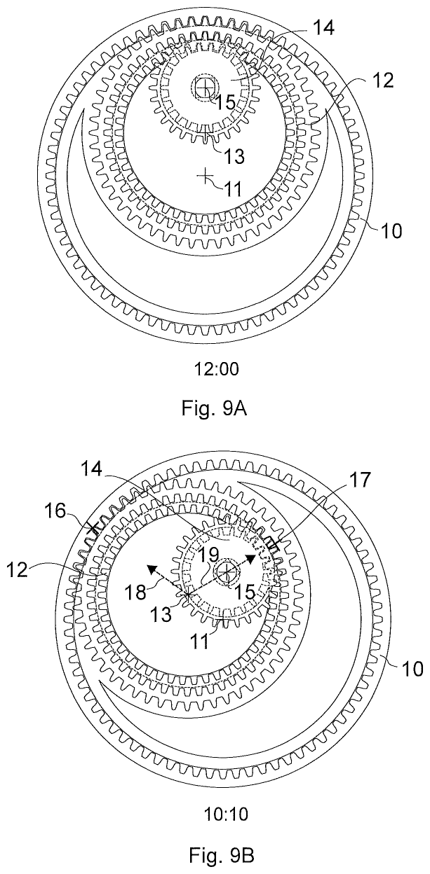

FIG. 9A shows a top plan view of a preferred embodiment of the drive train according to the invention. In the figure, the time indicated by the gear train is 12:00 o'clock. The gear train according to the invention comprises a base ring 10, an hour indicator means 12 adapted for rotary motion inside the base ring 10, and a minute indicator means 14 adapted for rotary motion inside the hour indicator means 12. The hour indicator means 12 and the minute indicator means 14 provide an indication of time displayed by a clock or watch.

The base ring 10 consists of at least one internal gear, the hour indicator means 12 and the minute indicator means 14 each also comprising at least one respective gear; the gears of the minute indicator means 14 preferably circle inside the gears of the hour indicator means 12, and the gears of the hour indicator means 12 circle inside the gears of the base ring 10.

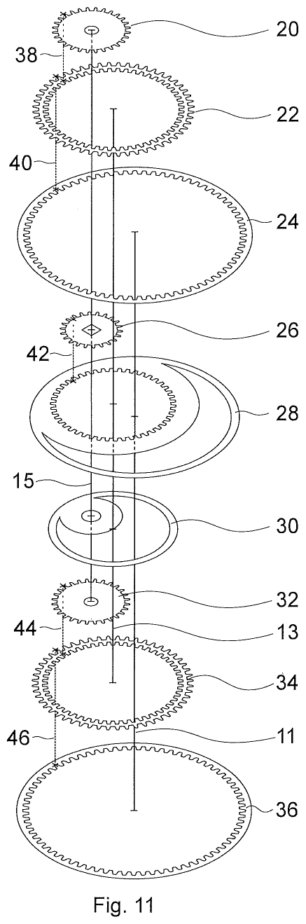

The gears of the base ring 10 have a common first axis 11 crossing their centre points. The hour indicator means 12 comprises an internal hour wheel 28 (see FIG. 11) and a dual-geared transmission gear 22 and/or 34 (see FIG. 11) that have a common second axis 13 crossing the centre point of the hour indicator means 12. The minute indicator means 14 comprises an external minute wheel 26 (see FIG. 11), and, as an additional gear, a drive gear 20 and/or a driven gear 32 (see FIG. 11) that have a common third axis 15 crossing the centre point of the minute indicator means 14.

In case the base ring 10 comprises multiple gears, the gears of the base ring 10 are preferably coupled together by the gears of the hour indicator means 12, more preferably are coupled together by the outside edge of the hour wheel 28. The engagement of the gears of the hour indicator means 12 is preferably ensured by the outside edge of the support 30 of the minute wheel 26, or in the case of appropriately designed teeth, the gears of the hour indicator means 12 are held together by radial interference. In a preferred embodiment, the gears of the minute indicator means 14 are coupled together by a coupling member arranged at the common third axis 15, in another embodiment, for example in a gear train preferably driven externally in a timed manner, the minute wheel 26, the drive gear 20 and the driven gear 32 is implemented as a single integrated piece, or, in a further preferred embodiment, the gears of the minute indicator means 14 are held together by radial interference (provided the teeth are designed appropriately).

The gear train according to FIG. 9A satisfies Formula 1, wherein
the first pitch surface 100A is the pitch surface of the inside of the transmission gear 22 and/or 34,
the second pitch surface 1006 is the pitch surface of the hour wheel 28,
the third pitch surface 100a is the pitch surface of the additional gear, that is, the pitch surface of the drive gear 20 and/or of the driven gear 32, and
the fourth pitch surface 100b is the pitch surface of the minute wheel 26.

Preferably, the gear train according to FIG. 9A also satisfies the relationship according to Formula 2, whereby the gear train is capable of efficient operation that is less sensitive to friction and to manufacturing inaccuracies.

The gears of the base ring 10, the hour indicator means 12 and/or the minute indicator means 14 preferably have a cycloid-based tooth profile, for example a so-called corrected cycloidal clock gear tooth profile, a so-called normal tooth profile, a “classic” cycloidal tooth profile, or other pseudo-cycloidal tooth profiles can also be applied. Cycloidal or pseudo-cycloidal gears minimize radial forces, and their instantaneous efficiency fluctuates to a smaller extent compared to the efficiency of other known gear types.

FIG. 9B shows the drive train according to FIG. 9A at another time instance, i.e. at 10:10. The hour indicator means 12 and the minute indicator means 14 are adapted to rotate with respect to the base ring 10, the hour indicator means 12 touches the base ring 10 at a first tangent point 16, indicating the hour value corresponding to the time instance at the time of reading, while the minute indicator means 14 touches the hour indicator means 12 at a second tangent point 17, and thereby defines the minute value corresponding to the time instant of the time of reading. In FIG. 9B it is also illustrated that, in the case of conventional timepieces the hour hand 18 would extend from the axis 13 of the hour indicator means 12 and would point towards the first tangent point 16, while the minute hand 19 would extend from the axis 13 of the hour indicator means 12 and would point towards the second tangent point 17. Reading of the indicated time is further facilitated by that the virtual hour hand 18 coincides with the straight line connecting the axis 11 of the base ring 10 and the axis 13 of the hour indicator means 12, and the virtual minute hand 19 coincides with the straight line connecting the axis 13 of the hour indicator means 12 and the axis 15 of the minute indicator means 14. This configuration allows for the instantaneous reading of the invention, so the special outward appearance does not involve a complex learning or reading process.

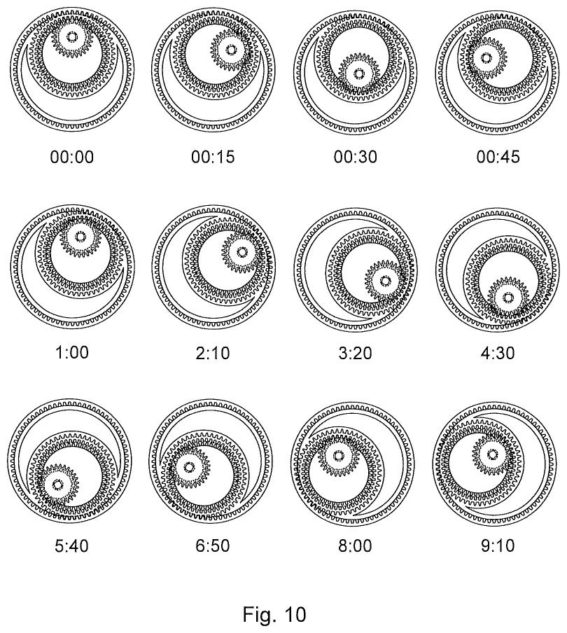

FIG. 10 shows the preferred embodiment of the gear train according to FIGS. 9A and 9B at further time instances. Thanks to the appropriately selected gear ratios, the indicated times can be read instantaneously even without marking the hour hand 18 and minute hand 19 that are shown in FIG. 9B.

FIG. 11 shows the isometric exploded view of a further preferred embodiment of the gear train according to the invention. The gear train comprises, as additional gears, a drive gear 20 and a driven gear 32, and comprises, as transmission gears, a drive-side transmission gear 22 and a driven-side transmission gear 34; and also comprises an adjustment gear 24, a minute wheel 26, an hour wheel 28, the support 30 of the minute wheel 26, and a base gear 36.

The base ring 10 comprises an adjustment gear 24 and a base gear 36 that have a common first axis 11 crossing the centre point of the base ring 10. The first axis 11 preferably also crosses the centre point of the external ring of the hour wheel 28, and thus the coupling of the adjustment gear 24 and the base gear 36 of the base ring 10 is provided by the outside edge of the hour wheel 28. A drive-side transmission gear 22 comprising a common second axis 13 crossing the centre point of the geared portions of the hour indicator means 12, the hour wheel 28, and the driven-side transmission gear 34 are integrated in the hour indicator means 12. The engagement of the gears of the minute indicator means 14 and the gears of the hour indicator means 12 is provided in a manner set forth in relation to FIG. 9A, i.e. by a radial interference occurring on meshed teeth, or by the configuration of the gears, for example the outside edge of the support 30 of the minute wheel 26. A drive gear 20 having a common third axis 15 crossing the centre point of the minute indicator means 14, the minute wheel 26, the support 30 of the minute wheel 26, and the driven gear 32 are integrated in the minute indicator means 14.

The relationship according to Formula 1 is satisfied for the gear train according to FIG. 11 in two cases. In the first case,
the first pitch surface 100A is the pitch surface of the inside face of the drive side transmission gear 22,
the second pitch surface 1006 is the pitch surface of the hour wheel 28,
the third pitch surface 100a is the pitch surface of the drive gear 20, and
the fourth pitch surface 100b is the pitch surface of the minute wheel 26,

while in the second case
the first pitch surface 100A is the pitch surface of the inside of the driven-side transmission gear 34,
the second pitch surface 1006 is the pitch surface of the hour wheel 28,
the third pitch surface 100a is the pitch surface of the driven gear 32, and
the fourth pitch surface 100b is the pitch surface of the minute wheel 26.

The drive-side transmission gear 22 is engaged with the drive gear 20 by means of its internal gearing, with the perpendicular projection of the tangent line segment of the drive-side transmission gear 22 and the drive gear 20 being a point 38, the drive-side transmission gear 22 being engaged with the adjustment gear 24 by means of its external gearing, with the perpendicular projection of the tangent line segment thereof being a point 40. The driven-side transmission gear 34 is engaged with the driven gear 32 by means of its internal gearing, with the perpendicular projection of the tangent line segment thereof being a point 44, said transmission gear 34 being engaged with the base gear 36 by means of its external gearing, with the perpendicular projection of the tangent line segment thereof being a point 46. The minute wheel 26 and the hour wheel 28 are also arranged such that the teeth of their gears are in engagement, with the perpendicular projection of tangent line segment of the minute wheel 26 and the hour wheel 28 being a point 42. A continuous tooth engagement is maintained by the meshing teeth of the gears.

In the two cases described above, the relationship according to Formula 2 is preferably also satisfied for the gear train.

In the preferred embodiment according to FIG. 11, the minute wheel 26 and the hour wheel 28 have to satisfy the relationship according to Formula 1 or Formula 2 in both of the above described cases.

In the preferred embodiment of the gear train according to FIG. 11, a distinction is made between a drive side and a driven side. The drive side comprises the drive gear 20, the drive-side transmission gear 22, the adjustment gear 24, the minute wheel 26 and the hour wheel 28, while the driven side comprises the support 30 of the minute wheel 26, the driven gear 32, the driven-side transmission gear 34, and the base gear 36.

In general, the drive-side transmission gear 22 is blocked, in a releasable manner, from rotating relative to the geared portion of the hour wheel 28 in the negative direction (in the clockwise direction), said rotation being allowed in the positive direction (in the counterclockwise direction). The adjustment gear 24 is allowed to rotate relative to the base gear 36 in a reversible or a switchable manner. The hour wheel 28 is adapted to rotate around the first axis 11 in the adjustment gear 24 such that the adjustment gear 24 is in constant engagement with the drive-side transmission gear 22. The hour wheel 28 is adapted to rotate in the base gear 36 about their common first axis 11, such that the base gear 36 is in constant engagement with the driven-side transmission gear 34. Under an effect of a motor, a weight, a spring, or other prime mover means, the drive gear 20 and the minute wheel 26 rotate relative to each other in the negative direction around their common axis 15. The drive gear 20 is in a continuous engagement with the drive-side transmission gear 22, the minute wheel 26 being in a continuous engagement with the geared inside portion of the hour wheel 28. The minute wheel 26 is connected to a common axis 15 with the driven gear 32 and the support 30 of the minute wheel 26. The minute wheel 26 and the driven gear 32 are fixed to each other during their rotation, said rotation with respect to the support 30 of the minute wheel 26 being blocked in a timed manner by means of a timer mechanism, preferably an escapement mechanism. The minute wheel 26 and the driven gear 32 is fixed to the timer mechanism preferably by a force-release link that is released under a large force, allowing the rotation of the minute wheel 26 and the driven gear 32 with respect to the timer mechanism. Such large forces can typically occur in a timepiece only when the time is being adjusted. The support 30 of the minute wheel 26 and the geared portion of the hour wheel 28 is arranged on a common axis 13, such that the minute wheel 26 is in constant engagement with the geared portion of the hour wheel 28, and the driven gear 32 is in constant engagement with the driven-side transmission gear 34.

During the operation of the movement, the drive-side transmission gear 22 is blocked from rotating in the negative direction with respect to the geared portion of the hour wheel 28, preferably by means of a direct or indirect releasable member. The drive gear 20 is rotated in the negative direction with respect to the minute wheel 26, preferably under the effect of an actuator, a spring, a motor, or other prime mover means. Due to the relative rotation of the drive gear 20 and the minute wheel 26, the drive gear 20 and the minute wheel 26 roll inside the drive-side transmission gear 22 and inside the hour wheel 28. In a manner characteristic for speed increasers, the pitch surface of the minute wheel 26 covers a shorter distance, when it rolls along the pitch surface of the hour wheel 28, than the pitch surface of the transmission gear 20 as it rolls along the pitch surface of the internal gearing of the drive-side transmission gear 22, which causes the displacement of the minute wheel 26 and the drive gear 20. Due to their common axis 15, this displacement causes the components of the minute indicator means 14 to rotate around axis 13 of the geared portion of the hour wheel 28. The rotation of the minute wheel 26 (caused by a rolling action) relative to the support 30 of the minute wheel 26, to the drive gear 20, or to another component is timed by a timer mechanism, preferably an escapement mechanism. The rotation of the minute wheel 26 is locked to the rotation of the driven gear 32, but their pitch surfaces are different, so the rolling of the minute wheel 26 inside the hour wheel 28—via the rotation of the driven gear 32—causes the driven-side transmission gear 34 to rotate with respect to the geared portion of the hour wheel 28, whereby the driven-side transmission gear 34 rolls inside the base gear 36. The driven-side transmission gear 34 rotates the hour wheel 28 (disposed on a common axis 13 therewith), furthermore the drive gear 20, the drive-side transmission gear 22, the minute wheel 26, the support 30 of the minute wheel 26, the driven gear 32, and the driven-side transmission gear 34 in contact with them around the axis 11 of the base gear 36. The adjustment gear 24 of the gear train also rotates to a small extent, but this displacement is not significant, and, on the other hand, it can be preferably eliminated by including a reversible, one-way rotation mechanism, more preferably a reversible ratchet mechanism in the gear train. The reversible one-way rotation mechanism is preferably disposed coupled to the first axis 11, the second axis 13, and/or the third axis 15.

When clock movement is wound up, the adjustment gear 24 is rotated directly or via a usual gear drive, in the positive direction under an external effect, i.e. a swinging weight, or other effect, the rotation of the adjustment gear 24 in turn causing the positive-direction rotation of the drive-side transmission gear 22 relative to the hour wheel 28. As with the motion during normal operation of the movement, the minute wheel 26 and the driven gear 32 then “try” to roll around axis 13 of the geared portion of the hour wheel 28 according to the normal motion of these components, which motion is blocked in a timed manner by a timer mechanism, preferably an escapement mechanism, coupled to the support 30 of the minute wheel 26, to the minute wheel 26, or to another gear. A small displacement of the adjustment gear 24 causes a positive-direction rotation of the drive gear 20 relative to the minute wheel 26. If the positive-direction rotational displacement of the drive gear 20 relative to the minute wheel 26 is greater than its negative-direction rotational displacement relative to its normal displacement during normal operation, then the spring or other prime mover means arranged between the drive gear 20 and the minute wheel 26 is driven in reverse with respect to its motion during normal operation, because, due to the timing, a motion that would be faster than the motion during normal operation cannot be produced. The resistance of the spring or other prime mover means against reverse-direction drive has to be chosen such that it does not release the force-release lock coupled to the timer mechanism.

When setting the time, a trivial switch, toggle, or other adjustment mechanism locks the position of the adjustment gear 24 relative to the base gear 36, and also allows the drive-side transmission gear 22 to rotate, in any direction, with respect to the geared portion of the hour wheel 28. Also, when the time is being set, under a direct or indirect external effect, the hour wheel 28 is rotated relative to the base gear 36 and the adjustment gear 24, which causes the transmission gears 22 and 34 to roll inside the base gear 36 and the adjustment gear 24. The internal teeth of the transmission gears 22 and 34 are rotated with respect to the teeth of the hour wheel 28, in a same manner as during normal operation, which causes the gears integrated in the minute indicator means 14 to rotate around the axis 13 of the geared portion of the hour wheel 28. Because during adjustment (i.e. during setting the time) the interactions between the drive-side gears are identical to the interactions between the gears on the driven side, wherein the drive gear 20 and the minute wheel 26 are not moved relative to each other. When setting the time, the internal forces to which the escapement mechanism is subjected can be much greater than during normal operation or winding, which can release the force-release lock coupled to the timer mechanism. During the winding and normal operation of the movement, the force-release lock is not released, the lock returning from its released state to its locked state when forces smaller than required for its release are present. The force-release lock can be preferably implemented, for example, by a friction shaft that is applied for time adjustment in most generic watch movements.

In addition to the spur gears presented hereinabove, the gear train according to FIG. 11 can also be realized by applying other trivial technical solutions, for example by bevel gears, hypoid gears, or, for example, chain transmission members, as well as non-circular pitch surfaces, such as a configuration similar to FIG. 4. In the case of applying chain transmission members, the supports included in the gear train can be realized by applying chain guide members.

The gear train can preferably include further hands (pointers), for example a second hand, or a pointer indicating the phases of the moon or the sun, which require the implementation of different speed increasing ratios in the gear train.

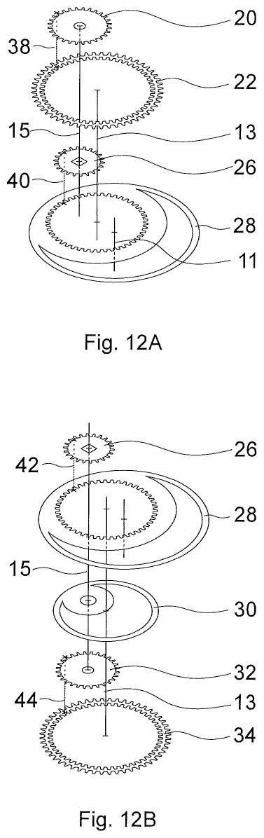

FIG. 12A shows another preferred embodiment of the gear train according to the invention, which embodiment comprises the drive-side components of the preferred gear train according to FIG. 11, i.e. the drive gear 20, the drive-side transmission gear 22, the minute wheel 26, and the hour wheel 28. In an identical manner to the embodiment described in relation to FIG. 11, this embodiment is also capable of displaying time on its own. The indicated time can be read by reading the position of the minute wheel 26 and the hour wheel 28. The features and alternatives described in relation to the corresponding components shown in FIG. 11 also apply to the embodiment according to FIG. 12A.

FIG. 12B shows a further preferred embodiment of the gear train according to the invention, which embodiment comprises the driven-side components of the preferred embodiment according to FIG. 11, i.e. the support 30 of the minute wheel 26, the driven gear 32 and the driven-side transmission gear 34, as well as the minute wheel 26 and the hour wheel 28. As with the embodiment described in relation to FIG. 12A, this gear train is also capable of displaying time on its own; the displayed time can be read by reading the position of the minute wheel 26 and the hour wheel 28. The features and alternatives described in relation to the corresponding components shown in FIG. 11 also apply to the embodiment according to FIG. 12B.

The manner of industrial application of the invention follows from the characteristics of the technical solution described above. As can be seen from the above, the invention achieves its objects in a very advantageous manner compared to the prior art. The invention is, of course, not limited to the preferred embodiments described in details above, but further variants, modifications and developments are possible within the scope of protection determined by the claims, for example by combining the embodiments described hereinabove, and potentially providing them with additional features.

### LEGENDS

10 base ring
11 first axis
12 hour indicator means
13 second axis
14 minute indicator means
15 third axis
16 first tangent point
17 second tangent point
18 hour hand
19 minute hand
20 drive gear
22 drive-side transmission gear
24 adjustment gear
26 minute wheel
28 hour wheel
30 support
32 driven gear
34 driven-side transmission gear
36 base gear
38 point
40 point
42 point
44 point
46 point
100A first pitch surface
100B second pitch surface
100a third pitch surface
100b fourth pitch surface
102A first line segment
102B second line segment
104 plane
T0 point
T1 origin
D point
C centre point
Q centre point
K, K′ projection point
P, P′ tooth contact point
E, E′ contact-line segment
F direction
R direction
I. area (according to Formula 1)
II. area (according to Formula 2)

1. A two-stage speed increaser arrangement comprising force transmission members having a first pitch surface (100A), a second pitch surface (100B), a third pitch surface (100a), and a fourth pitch surface (100b), wherein, in a first stage, the third pitch surface (100a) rolls along the first pitch surface (100A), and, in a second stage, the fourth pitch surface (100b) rolls along the second pitch surface (100B), such that the first pitch surface (100A) and the third pitch surface (100a) have a common first line segment (102A) and the second pitch surface (100B) and the fourth pitch surface (100b) have a common second line segment (102B), wherein both stages have at least one respective tooth contact region, arranged spaced apart with respect to the line segments (102A, 102B), along which the force transmission members of the first and second stages are engaged, and the first and second pitch surfaces (100A, 100B) have a fixed relative position at the first and second line segments (102A, 102B), and the third and fourth pitch surfaces (100a, 100b) also have a fixed relative position at the first and second line segments (102A, 102B),
characterised in that
considering an orthogonal coordinate system in a plane (104) perpendicular to the second line segment (102B), wherein an origin (T1) of the orthogonal coordinate system is a projection of the second line segment (102B) to the plane (104),
and considering that the Y axis of the coordinate system is pointing in the direction of a projection point (T0) of a point (D) of the first line segment (102A) to the plane (104), the following Formula 1 is satisfied at all times for the arrangement, in a coordinate system defined for each point (D) of the first line segment (102A):
x(((y′+d)x—x′y)(x²+y²−y)+d²xy)≥0, Formula 1
wherein
d is the distance of the projection point (T0) from the origin (T1),
x and y are the coordinates of a projection point (K), as projected to the plane (104), of an arbitrary tooth contact point (P) within any tooth contact region of the first pitch surface (100A) and the third pitch surface (100a), and
x′ and y′ are the coordinates of a projection point (K′), as projected to the plane (104), of an arbitrary tooth contact point (P′) within any tooth contact region of the second pitch surface (100B) and the fourth pitch surface (100b).

2. The arrangement according to claim 1, characterised in that it also satisfies the following Formula 2 at all times:
x(y′x−x′y)(x²+y²−dy)≥0. Formula 2

3. The arrangement according to claim 1, characterised in that at least one of the force transmission members is a gear member, preferably a gear wheel, a bevel gear, a helical gear, a spiral gear, or hypoid gear, the other force transmission members being gear members and/or chain transmission members, preferably a chain or a sprocket.

4. A gear train for a clockwork, for example for a watch, having a two-stage speed increaser arrangement according to claim 1, the gear train comprising a base ring (10), an hour indicator means (12) circling inside the base ring (10), and a minute indicator means (14) circling inside the hour indicator means (12), characterised in that
the base ring (10) consists of at least one gear with internal gearing,
the hour indicator means (12) comprises an internal hour wheel (28) and a transmission gear (22, 34) with both external gearing and internal gearing, having a common axis (13) crossing the centre point of the hour indicator means (12),
the minute indicator means (14) comprises a minute wheel (26) with external gearing and an additional gear with external gearing, having a common axis (15) crossing the centre point of the minute indicator means (14),
the teeth of the minute wheel (26) and the hour wheel (28) are in mesh with each other,
the teeth of the external gearing of the transmission gear (22, 34) are engaging the gear of the base ring (10), with teeth of the internal gearing thereof engaging the additional gear, and
the gear train satisfies the following formula:
x(((y′+d)x−x′y)(x²+y²−dy)+d²xy)≥0, Formula 1,
where
a first pitch surface (100A) is a pitch surface of the internal gearing of the transmission gear (22, 34),
a second pitch surface (100B) is a pitch surface of the hour wheel (28),
a third pitch surface (100a) is a pitch surface of the additional gear, and
a fourth pitch surface (100b) is a pitch surface of the minute wheel (26).

5. The gear train according to claim 4, characterised in that the base ring (10) comprises an adjustment gear (24) as a gear with internal gearing, the additional gear is a drive gear (20), and the transmission gear is a drive-side transmission gear (22); wherein the teeth of the internal gearing of the drive-side transmission gear (22) is engaging the drive gear (20), and with the teeth of the external gearing thereof engaging the adjustment gear (24).

6. The gear train according to claim 4, characterised in that the base ring (10) comprises a base gear (36) as a gear with internal gearing, the additional gear is a driven gear (32), and the transmission gear is a driven-side transmission gear (34); the teeth of the internal gearing of the driven-side transmission gear (34) are engaging the driven gear (32), the teeth of the external gearing thereof engaging the base gear (36).

7. The gear train according to claim 4, characterised in that
the base ring (10) comprises an adjustment gear (24) and a base gear (36) as gears with internal gearing, that comprise a common first axis (11) crossing the centre point of the base ring,
a drive-side transmission gear (22), the hour wheel (28), and a driven-side transmission gear (34), all having a common second axis (13) crossing the centre point of the hour indicator means (12), are integrated in the hour indicator means (12), with
a drive gear (20), the minute wheel (26), a support (30), and a driven gear (32), all having a common third axis (15) crossing the centre point of the minute indicator means (14), being integrated in the minute indicator means (14),
the teeth of the internal gearing of the drive-side transmission gear (22) are engaging the drive gear (20), with the teeth of the external gearing thereof engaging the adjustment gear (24),
the teeth of the minute wheel (26) and the hour wheel (28) are in mesh with each other,
the teeth of the internal gearing of the driven-side transmission gear (34) are engaging the driven gear (32), the teeth of the external gearing thereof engaging the base gear (36).

8. The gear train according to claim 4, characterised in that a timer mechanism, preferably an escapement mechanism, is connected to the minute wheel (26) or the additional gear.

9. The gear train according to claim 4, characterised in that a tooth profile of the gears of the base ring (10) and/or the hour indicator means (12) and/or the minute indicator means (14) is shaped as a corrected cycloidal clock gear tooth profile.

10. The gear train according to claim 7, characterised in that the first axis (11) and/or the second axis (13) and/or the third axis (15) comprises a reversible one-way rotation mechanism.

11. The gear train according to claim 10, characterised in that the one-way rotation mechanism is implemented as a reversible ratchet mechanism.
